(19) United States
(12) Patent Application Publication
(10) Pub. No.: US 2025/0252573 A1
(43) Pub. Date: Aug. 7, 2025

(54) METHOD FOR ANALYZING AORTIC COMPUTED TOMOGRAPHY IMAGES AND SYSTEM IMPLEMENTING THE SAME

(71) Applicant: Chang Gung Memorial Hospital, Linkou, Taoyuan City (TW)

(72) Inventors: Li-Jen Wang, New Taipei City (TW); Cheng-Yu Ma, Taoyuan City (TW); Chang-Fu Kuo, Taoyuan City (TW); Chun-Bi Chang, Taoyuan City (TW); Hung-Hsien Liu, Taoyuan City (TW); Yi-Sa Chen, Taoyuan City (TW); Chun-Yu Lin, Taoyuan City (TW)

(73) Assignee: Chang Gung Memorial Hospital, Linkou, Taoyuan City (TW)

(21) Appl. No.: 18/936,606

(22) Filed: Nov. 4, 2024

(30) Foreign Application Priority Data
Feb. 7, 2024 (TW) 113105065

(51) Int. Cl. G06T 7/00

(52) U.S. Cl. CPC G06T 7/0014; G06T 2207/10081; G06T 2207/30048; G06T 2207/30101

(57) ABSTRACT

A method for analyzing aortic CT images includes: receiving multiple original CT images and selecting a sequence of chest CT images therefrom; generating, using a part detection model, for each of the chest CT images, a detection result that indicates whether the chest CT image represents an ascending aorta; generating, using a status analysis model, for each of the chest CT images, an analysis result that indicates whether the chest CT image shows aortic dissection; and when determining that at least N chest CT image(s) from consecutive M number of the chest CT images show aortic dissection, determining whether the detection result of at least one of the at least N chest CT image(s) represents an ascending aorta, and if affirmative, generating a type A aortic dissection result or otherwise, generating a type B aortic dissection result.

### CROSS-REFERENCE TO RELATED APPLICATION

This application claims priority to Taiwanese Invention patent application No. 113105065, filed on Feb. 7, 2024, the entire disclosure of which is incorporated by reference herein.

### FIELD

The disclosure relates to a method for analyzing computed tomography (CT) images and a system implementing the same, and more particularly to a method for analyzing aortic CT images using artificial intelligence, and a system implementing the same.

### BACKGROUND

Aortic dissection is a relatively rare but potentially fatal cardiovascular disease. It can lead to insufficient blood supply to the heart or aortic rupture, both of which can be fatal. Clinically, accurate determination of aortic dissection from CT images usually relies on professional experience of a physician.

### SUMMARY

Therefore, an object of the disclosure is to provide a method for analyzing CT images and a system implementing the same that can automatically analyze the status of the aorta of the patient, thereby shortening a time interval between the patient taking the chest CT images and the doctors performing treatment to the patient, which may reduce the risk of death of patients with aortic dissection.

According to an aspect of the disclosure, a method for analyzing aortic computed tomography (CT) images is implemented by a processor and includes the following. The processor receives a plurality of original CT images that are related to a patient and that are in sequential order, and selects a sequence of chest CT images from the original CT images, where the chest CT images are those of the original CT images that include a chest portion of the patient and that are in sequential order. For each of the chest CT images, the processor inputs the chest CT image into a part detection model that is generated using deep learning, so as to generate a detection result that is related to the chest CT image, where the detection result indicates whether the chest CT image represents an ascending aorta. For each of the chest CT images, the processor inputs the chest CT image into a status analysis model that is generated using deep learning, so as to generate an analysis result that is related to the chest CT image, where the analysis result indicates whether the chest CT image shows aortic dissection. The processor makes a first determination on whether among consecutive M chest CT images of the plurality of chest CT images, there is at least N chest CT image(s) the analysis result of each of which shows aortic dissection, where M and N are positive integers, and N is not greater than M. In response to the first determination being affirmative, the processor makes a second determination on whether the detection result that is related to at least one of the at least N chest CT image(s) represents an ascending aorta. In response to the second determination being affirmative, the processor generates a first classification result that indicates type A aortic dissection; and in response to the second determination being negative, the processor generates a second classification result that indicates type B aortic dissection.

According to another aspect of the disclosure, a system for analyzing aortic CT images includes a storage medium and a processor. The processor is electrically connected to the storage medium and is configured to receive a plurality of original CT images that are related to a patient and that are in sequential order, and to select a sequence of chest CT images from the original CT images, where the chest CT images are those of the original CT images that include a chest portion of the patient and that are in sequential order. The processor is further configured to, for each of the chest CT images, input the chest CT image into a part detection model that is generated using deep learning, so as to generate a detection result that is related to the chest CT image, where the detection result indicates whether the chest CT image represents an ascending aorta. The processor is further configured to, for each of the chest CT images, input the chest CT image into a status analysis model that is generated using deep learning, so as to generate an analysis result that is related to the chest CT image, where the analysis result indicates whether the chest CT image shows aortic dissection. The processor is further configured to make a first determination on whether among consecutive M chest CT images of the plurality of chest CT images, there is at least N chest CT image(s) the analysis result of each of which shows aortic dissection, where M and N are positive integers, and N is not greater than M. The processor is further configured to, in response to the first determination being affirmative, make a second determination on whether the detection result that is related to at least one of the at least N chest CT image(s) represents an ascending aorta. The processor is further configured to, in response to the second determination being affirmative, generate a first classification result that indicates type A aortic dissection, and in response to the second determination being negative, generate a second classification result that indicates type B aortic dissection.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for analyzing aortic CT images according to an embodiment of the disclosure.

FIG. 2 is a flow chart illustrating a procedure for generating a part detection model and a status analysis model according to an embodiment of the disclosure.

FIG. 3 is a flow chart illustrating a method for analyzing aortic CT images according to an embodiment of the disclosure.

FIG. 4 is a schematic view illustrating acquisition of a plurality of original CT images and a sequence of chest CT images.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

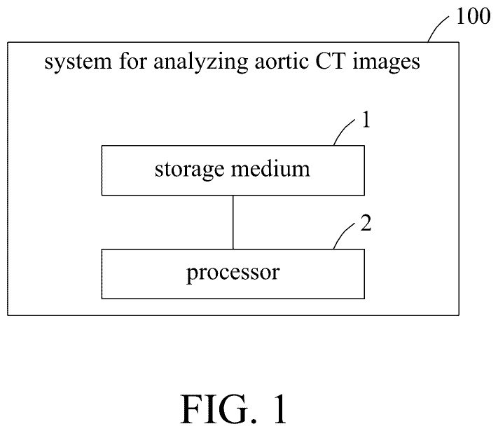

Referring to FIG. 1, a method for analyzing aortic computed tomography (CT) images according to an embodiment of the disclosure is implemented by a system 100. The system 100 includes a storage medium 1 and a processor 2, where the processor 2 is electrically connected to the storage medium 1.

The storage medium 1 may be embodied using one or more non-volatile storage mediums such as hard disk drives, solid state drives, read only memory (ROM), programmable ROM (PROM), flash memory, etc.

The processor 2 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), a system on a chip (SoC), etc.

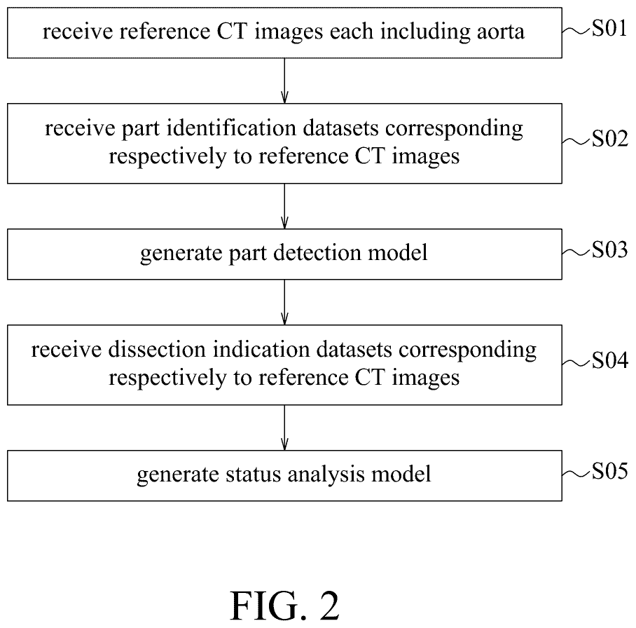

Referring further to FIG. 2, a procedure for generating a part detection model and a status analysis model includes steps S01 to S05. In step S01, the processor 2 receives a plurality of reference CT images, each of which includes an aorta.

In step S02, the processor 2 receives a plurality of part identification datasets corresponding respectively to the reference CT images. Each of the part identification datasets indicates which one of an ascending aorta, an aortic arch, and a descending aorta the corresponding one of the reference CT images represents.

In step S03, the processor 2 inputs the reference CT images and the part identification datasets into a deep learning model for object detection (e.g., RetinaNet50), so as to generate the part detection model. In this embodiment, the deep learning model is implemented by RetinaNet50, but the disclosure is not limited to such.

In step S04, the processor 2 receives a plurality of dissection indication datasets corresponding respectively to the reference CT images. Each of the dissection indication datasets indicates whether the corresponding one of the reference CT images shows aortic dissection.

In step S05, the processor 2 inputs the reference CT images and the dissection indication datasets into another deep learning model for image classification (e.g., EfficientNet-b0), so as to generate the status analysis model. In this embodiment, the another deep learning model is implemented by EfficientNet-b0, but the disclosure is not limited to such.

It should be noted that the order of the steps in the procedure is not limited to the abovementioned example. In some embodiments, steps S04 and S05 are performed after step S01 and before steps S02 and S03.

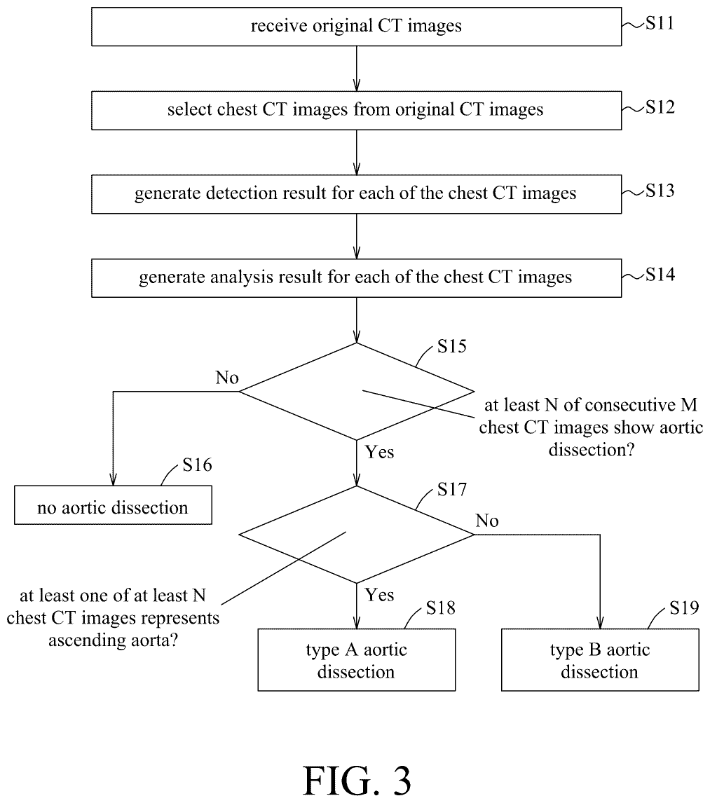

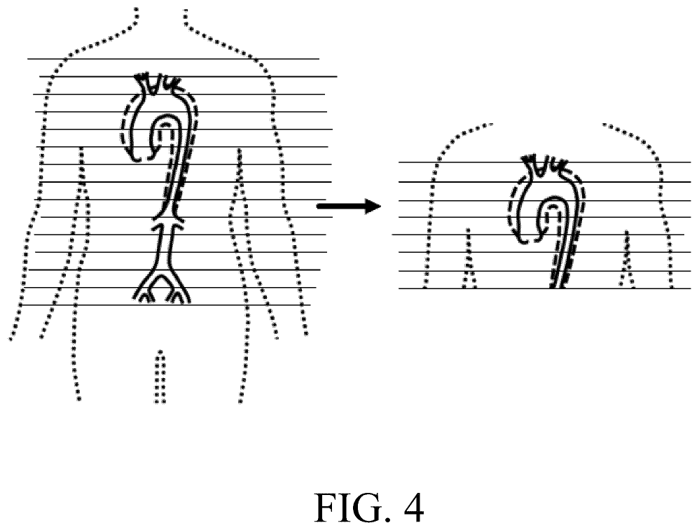

Referring further to FIGS. 3 and 4, a flow of the method for analyzing aortic CT images includes steps S11 to S19. In step S11, the processor 2 receives a plurality of original CT images that are related to a patient and that are in sequential order. Each of the original CT images shows a cross section of the patient taken along, for example, a respective one of the horizontal lines on the left of FIG. 4.

In step S12, the processor 2 selects a sequence of chest CT images from the original CT images, where the chest CT images are those of the original CT images that include a chest portion of the patient and that are in sequential order (as shown on the right of FIG. 4). In this embodiment, the processor 2 uses an image recognition technology to select the chest CT images, but the disclosure is not limited to such.

In step S13, for each of the chest CT images, the processor 2 inputs the chest CT image into the part detection model that is generated using deep learning, so as to generate a detection result that is related to the chest CT image, where the detection result indicates whether the chest CT image represents an ascending aorta. In accordance with some embodiments, the detection result indicates which one of an ascending aorta, an aortic arch, and a descending aorta the chest CT image represents.

In step S14, for each of the chest CT images, the processor 2 inputs the chest CT image into the status analysis model that is generated using deep learning, so as to generate an analysis result that is related to the chest CT image, where the analysis result indicates whether the chest CT image shows aortic dissection. It should be noted that the order of steps S13 and S14 is not limited to the abovementioned example. In some embodiments, step S14 is performed before step S13.

In step S15, the processor 2 makes a first determination on whether among consecutive M chest CT images of the plurality of chest CT images, there is at least N chest CT image(s) the analysis result of each of which shows aortic dissection. Specifically, M and N are positive integers, and N is not greater than M. In this embodiment, M is equal to 7, and N is equal to 5, but the disclosure is not limited to such. When the first determination made in step S15 is negative, the flow proceeds to step S16; otherwise, the flow proceeds to step S17.

In step S16, in response to the first determination being negative, the processor 2 generates a first classification result that indicates no aortic dissection.

In step S17, in response to the first determination being affirmative, the processor 2 makes a second determination on whether the detection result that is related to at least one of the at least N chest CT image(s) represents an ascending aorta (i.e., whether any of the detection results that are generated respectively for the at least N chest CT image(s) indicates an ascending aorta). When the second determination is affirmative, the flow proceeds to step S18; otherwise, the flow proceeds to step S19.

In step S18, in response to the second determination being affirmative, the processor 2 generates a second classification result that indicates type A aortic dissection.

In step S19, in response to the second determination being negative, the processor 2 generates a third classification result that indicates type B aortic dissection.

In one example where M=7 and N=5, seven consecutive chest CT images (labelled as 011-017) and their corresponding analysis results and detection results are shown in Table 1 below. Among the seven (M) chest CT images, there are six chest CT images (labelled as 012-017) whose corresponding analysis results show aortic dissection. Therefore, the first determination made in step S15 will be affirmative (six satisfies “at least five (N)”).

The detection results corresponding to five of those six chest CT images (labelled as 013-017) represent an ascending aorta. Therefore, the second determination made in step S17 will be affirmative (“five of six” satisfies “at least one of at least five (N)”), and thus the processor 2 generates the second classification result that indicates type A aortic dissection in step S18.

TABLE 1

| Chest CT Images | Analysis Result | Detection Result |
|---|---|---|
| . . . | . . . | . . . |
| 011 | no aortic dissection | aortic arch |
| 012 | aortic dissection | aortic arch |
| 013 | aortic dissection | ascending aorta |
| 014 | aortic dissection | ascending aorta |
| 015 | aortic dissection | ascending aorta |
| 016 | aortic dissection | ascending aorta |
| 017 | aortic dissection | ascending aorta |
| . . . | . . . | . . . |

By virtue of the method provided in the disclosure, after original CT images of the patient have been taken, the processor 2 is able to notify doctors of the status of the aorta of the patient within a few minutes. The doctors may then make a diagnosis within a few minutes after receiving the notification from the processor 2, and immediately perform treatments on the patient if needed.

In summary, according to the disclosure, for each of the chest CT images, the processor 2 inputs the chest CT image into the part detection model and the status analysis model so as to generate the detection result and the analysis result respectively. Then, the processor 2 makes the first determination on whether among consecutive M chest CT images of the plurality of chest CT images, there is at least N chest CT image(s) the analysis result of each of which shows aortic dissection, and makes the second determination on whether at least one of the detection results generated respectively for the at least N chest CT image(s) represents an ascending aorta, so as to generate the first classification result, the second classification result, or the third classification result. As such, the method and the system provided in the disclosure may automatically analyze the status of the aorta from the chest CT images, thereby effectively shortening a time interval between the time the chest CT images are taken and the time treatment is performed on the patient, which may reduce the risk of death of patients with aorta dissection.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for analyzing aortic computed tomography (CT) images, the method being implemented by a processor and comprising:
receiving a plurality of original CT images that are related to a patient and that are in sequential order;
selecting a sequence of chest CT images from the original CT images, where the chest CT images are those of the original CT images that include a chest portion of the patient and that are in sequential order;
for each of the chest CT images, inputting the chest CT image into a part detection model that is generated using deep learning, so as to generate a detection result that is related to the chest CT image, where the detection result indicates whether the chest CT image represents an ascending aorta;
for each of the chest CT images, inputting the chest CT image into a status analysis model that is generated using deep learning, so as to generate an analysis result that is related to the chest CT image, where the analysis result indicates whether the chest CT image shows aortic dissection;
making a first determination on whether among consecutive M chest CT images of the plurality of chest CT images, there is at least N chest CT image(s) the analysis result of each of which shows aortic dissection, where M and N are positive integers, and N is not greater than M;
in response to the first determination being affirmative, making a second determination on whether the detection result that is related to at least one of the at least N chest CT image(s) represents an ascending aorta;
in response to the second determination being affirmative, generating a first classification result that indicates type A aortic dissection; and
in response to the second determination being negative, generating a second classification result that indicates type B aortic dissection.

2. The method as claimed in claim 1, further comprising:
in response to the first determination being negative, generating a third classification result that indicates no aortic dissection.

3. The method as claimed in claim 1, further comprising, before inputting the chest CT images into the status analysis model:
receiving a plurality of reference CT images, each of which includes an aorta;
receiving a plurality of dissection indication datasets corresponding respectively to the reference CT images, where each of the dissection indication datasets indicates whether the corresponding one of the reference CT images shows aortic dissection; and
inputting the reference CT images and the dissection indication datasets into a deep learning model, so as to generate the status analysis model.

4. The method as claimed in claim 1, further comprising, before inputting the chest CT images into the part detection model:
receiving a plurality of reference CT images, each of which includes an aorta;
receiving a plurality of part identification datasets corresponding respectively to the reference CT images, where each of the part identification datasets indicates which one of an ascending aorta, an aortic arch, and a descending aorta the corresponding one of reference CT images represents; and
inputting the reference CT images and the part identification datasets into a deep learning model, so as to generate the part detection model.

5. A non-transitory computer readable storage medium storing a computer program that is configured to, when executed by a processor of a computer, cause the processor to perform the method as claimed in claim 4.

6. A non-transitory computer readable storage medium storing a computer program that is configured to, when executed by a processor of a computer, cause the processor to perform the method as claimed in claim 3.

7. A non-transitory computer readable storage medium storing a computer program that is configured to, when executed by a processor of a computer, cause the processor to perform the method as claimed in claim 2.

8. A non-transitory computer readable storage medium storing a computer program that is configured to, when executed by a processor of a computer, cause the processor to perform the method as claimed in claim 1.

9. A system for analyzing aortic computed tomography (CT) images, comprising:
a storage medium; and
a processor electrically connected to said storage medium and configured to:
receive a plurality of original CT images that are related to a patient and that are in sequential order,
select a sequence of chest CT images from the original CT images, where the chest CT images are those of the original CT images that include a chest portion of the patient and that are in sequential order,
for each of the chest CT images, input the chest CT image into a part detection model that is generated using deep learning, so as to generate a detection result that is related to the chest CT image, where the detection result indicates whether the chest CT image represents an ascending aorta,
for each of the chest CT images, input the chest CT image into a status analysis model that is generated using deep learning, so as to generate an analysis result that is related to the chest CT image, where the analysis result indicates whether the chest CT image shows aortic dissection,
make a first determination on whether among consecutive M chest CT images of the plurality of chest CT images, there is at least N chest CT image(s) the analysis result of each of which shows aortic dissection, where M and N are positive integers, and N is not greater than M,
in response to the first determination being affirmative, make a second determination on whether the detection result that is related to at least one of the at least N chest CT image(s) represents an ascending aorta,
in response to the second determination being affirmative, generate a first classification result that indicates type A aortic dissection, and
in response to the second determination being negative, generate a second classification result that indicates type B aortic dissection.

10. The system as claimed in claim 9, wherein said processor is further configured to, in response to the first determination being negative, generate a third classification result that indicates no aortic dissection.

11. The system as claimed in claim 9, wherein said processor is further configured to:
receive a plurality of reference CT images, each of which includes an aorta;
receive a plurality of dissection indication datasets corresponding respectively to the reference CT images, where each of the dissection indication datasets indicates whether the corresponding one of the reference CT images shows aortic dissection; and
train a default analysis model based on the reference CT images and the dissection indication datasets, so as to generate the status analysis model.

12. The system as claimed in claim 9, wherein said processor is further configured to:
receive a plurality of reference CT images, each of which includes an aorta;
receive a plurality of part identification datasets corresponding respectively to the reference CT images, where each of the part identification datasets indicates which one of an ascending aorta, an aortic arch, and a descending aorta the corresponding one of the reference CT images represents; and
train a default detection model based on the reference CT images and the part identification datasets, so as to generate the part detection model.
